(19) United States
(12) Patent Application Publication
(10) Pub. No.: US 2011/0176241 A1
(43) Pub. Date: Jul. 21, 2011

(54) DISK SPACER FOR DATA STORAGE DEVICE AND HARD DISK DRIVE HAVING THE SAME

(75) Inventors: Kyung Ho KIM, Seoul (KR); Ha Yong Kim, Seoul (KR); Cheol-Soon Kim, Anyang-si (KR)

(73) Assignee: Samsung Electronics Co., Ltd, Suwon-si (KR)

(21) Appl. No.: 12/943,077

(22) Filed: Nov. 10, 2010

(30) Foreign Application Priority Data
Jan. 19, 2010 (KR) 10-2010-0004586

(51) Int. Cl. G11B 17/08

(52) U.S. Cl. 360/98.08; G9B/17.041

(57) ABSTRACT

A hard disk drive includes a hub on which a plurality of disks are rotatably assembled, and a spacer assembled to the hub to be alternately arranged with the disks to separate the disks and having at least one area of an inner wall surface that elastically contacts and is pressed against an outer wall surface of the hub for centering with respect to the hub.

### CROSS-REFERENCE TO RELATED APPLICATIONS

This application claims the benefit of Korean Patent Application No. 10-2010-0004586, filed on Jan. 19, 2010, in the Korean Intellectual Property Office, the disclosure of which is incorporated herein in its entirety by reference.

### BACKGROUND

1. Field of the Invention

The inventive concept relates to a disk spacer for a data storage device and a hard disk drive (HDD) having the same, and more particularly, to a disk spacer for a data storage device having a simple structure and capable of being automatically centered with respect to a hub so that a disk may be easily centered without expensive equipment, a quality characteristic of each disk may be maintained constant, and an influence on repeatable run out (RRO) or non-repeatable run out (NRRO) may be prevented, and an HDD having the same.

2. Description of the Related Art

When servo track writing (STW) is performed on a disk by using a STW apparatus or an HDD is manufactured, a plurality of disks are assembled on a rotation shaft that is referred to as a hub. A spacer is interposed between the disks for maintenance space between the disks.

When a disk is assembled on a hub, it is ideal that the rotation center of the hub and the rotation center of the disk completely match with each other, that is, the centering of a disk with respect to the hub is accomplished. However, due to a degree of processing or assembly allowance between parts, it is difficult not only to accomplish the complete centering of the disk with respect to the hub, but also to reach a necessary range, by simply assembling the disk on the hub. A centering process is performed during the assembly of a disk.

In particular, when a plurality of disks are assembled on the hub, a spacer having a great influence on a degree of the centering of disks is interposed between the disks. Also, since it is practically difficult to make allowance between the hub and the spacer tight to a desired degree, the centering process is performed.

In order to omit the centering process, the allowance between the hub and the spacer needs to be overly tight. Accordingly, the amount of overall imbalance of the spacer and the disks with respect to the hub is greatly reduced so that the centering process may not be required. In this case, however, assembly becomes difficult and, in particular, it is difficult to pull the spacer down to a lower portion of the hub so as to stack the spacer and the disks in order. If the spacer is assembled to the hub by being forcibly pulled down, particles may be generated due to scratches or stabs of the hub so that a bad influence may be on the quality of a product in the STW process or a product assembly process.

Thus, the hub and the spacer are manufactured to allow a certain degree of allowance therebetween. In this case, although the assembly of the spacer and the disk with respect to the hub is made easier, more time or effects are consumed in the centering process after the assembly thereof and thus a process loss may be generated.

The following techniques are examples of well-known centering methods.

First, a spacer or a disk is pushed by its lateral side in one direction and an amount of movement of the spacer or disk is measured. Then, the spacer or disk is pushed in the opposite direction as much as half of the amount of movement, thereby centering the spacer or disk.

Second, the imbalance amount between the disks and hub is measured in a state when the disks are assembled on the hub. Then, an impact is applied to the lateral side of a disk until the imbalance amount becomes the minimum. This is referred to as a dynamic imbalance method.

Third, when a plurality of disks are to be assembled, the disks are assembled in form of zigzag or biasing by pushing one to one end and the other to the opposite end, thereby reducing the imbalance amount in terms of probability.

Fourth, the imbalance amount of measured during assembly of a disk and a mass balance is added to a side having a relatively smaller imbalance amount.

Nevertheless, most of the above conventional centering methods reduces the imbalance amount not by precisely performing the disk centering, but by employing an addition process by measuring the imbalance amount after assembly, or merely allow basic imbalance of a disk to a degree. Thus, the quality characteristic of each disk varies so that a recording characteristic or a mass production characteristic may be badly affected.

In particular, even when a centering process is performed by the above-described centering method using expensive centering equipment or imbalance equipment, a slip phenomenon may be generated during rotation of a disk and thus setting values may be changed from the initial ones. Therefore, the quality characteristic, for example, RRO or NRRO during STW or use of an HDD, may be affected.

### SUMMARY

The inventive concept provides a disk spacer for a data storage device having a simple structure and capable of being automatically centered with respect to a hub so that a disk may be easily centered without expensive equipment, a quality characteristic of each disk may be maintained constant, and an influence on repeatable run out (RRO) or non-repeatable run out (NRRO) may be prevented, and a hard disk drive (HDD) having the same.

According to an aspect of the inventive concept, there is provided a hard disk drive including a hub on which a plurality of disks are rotatably assembled, and a spacer assembled to the hub to be alternately arranged with the disks to separate the disks and having at least one area of an inner wall surface that elastically contacts and is pressed against an outer wall surface of the hub for centering with respect to the hub.

The spacer may include a body portion having a ring shape, in which a plurality of through holes are formed at positions separated at the same interval in a circumferential direction, and an elastic band formed of an elastic material and coupled to an outside of the body portion to partially pass through the plurality of through holes and elastically contact and be pressed against the outer wall surface of the hub.

The elastic band may include a plurality of linear sections formed at the same interval, arranged in areas of the plurality of through holes to respectively correspond to the areas of the plurality of through holes, and partially passing through the plurality of through holes to elastically contact and be pressed against the outer wall surface of the hub, and a plurality of circular sections respectively arranged between the plurality of linear sections.

The hard disk drive may further include a seating groove formed in the outer wall surface of the body portion, the elastic band being arranged in the seating groove.

The seating groove may be continuously formed in a circumferential direction of the body portion in the outer wall surface of the body portion.

The hard disk drive may further include a sunken groove formed in the seating groove where the plurality of linear sections are arranged, the sunken groove being sunken inwardly in a radial direction deeper than a depth of the seating groove.

The material of the elastic band may be fluorine rubber or silicon rubber.

The plurality of through holes may be three long holes processed to have the same shape in a circumferential direction of the body portion.

According to another aspect of the inventive concept, there is provided a disk spacer for a data storage device that is assembled to a hub to be alternately arranged with disks to separate the disks and is automatically centered with respect to the hub, the disk spacer including a body portion having a ring shape, in which a plurality of through holes are formed at positions separated at the same interval in a circumferential direction, and an elastic band formed of an elastic material and coupled to an outside of the body portion to partially pass through the plurality of through holes and elastically contact and be pressed against an outer wall surface of the hub.

The elastic band may include a plurality of linear sections formed at the same interval, arranged in areas of the plurality of through holes to respectively correspond to the areas of the plurality of through holes, and partially passing through the plurality of through holes to elastically contact and be pressed against the outer wall surface of the hub, and a plurality of circular sections respectively arranged between the plurality of linear sections.

The disk spacer may further include a seating groove continuously formed in the outer wall surface of the body portion in a circumferential direction of the body portion, the elastic band being arranged in the seating groove.

The disk spacer may further include a sunken groove formed in the seating groove where the plurality of linear sections are arranged, the sunken groove being sunken inwardly in a radial direction deeper than a depth of the seating groove.

The material of the elastic band may be fluorine rubber or silicon rubber and the plurality of through holes may be three long holes processed to have the same shape in a circumferential direction of the body portion.

### BRIEF DESCRIPTION OF THE DRAWINGS

Exemplary embodiments of the inventive concept will be more clearly understood from the following detailed description taken in conjunction with the accompanying drawings in which:

FIG. 1 is an exploded perspective view of an HDD according to an exemplary embodiment of the inventive concept;

FIG. 2 is a cross-sectional view of the HDD of FIG. 1;

FIG. 3 is an exploded perspective view of the hub and the spacer of FIG. 2;

FIGS. 4A and 4B are plan views illustrating a process in which the spacer is assembled on the hub;

FIG. 5 is an exploded perspective view of the spacer according to an exemplary embodiment of the inventive concept;

FIG. 6 is a plan view of an elastic band according to an exemplary embodiment of the inventive concept;

FIG. 7 is a plan view of an elastic band of a spacer according to another exemplary embodiment of the inventive concept;

FIG. 8 is a plan view of a spacer employing the elastic band of FIG. 7;

FIG. 9 is a perspective view of an offline servo track writing apparatus employing the spacer according to an exemplary embodiment of the present inventive concept; and

FIG. 10 is an exploded perspective view of a disk holder, a disk and a spacer.

### DETAILED DESCRIPTION OF THE EMBODIMENTS

The attached drawings for illustrating embodiments of the inventive concept are referred to in order to gain a sufficient understanding of the inventive concept and the merits thereof. Hereinafter, the inventive concept will be described in detail by explaining embodiments of the inventive concept with reference to the attached drawings. Like reference numerals in the drawings denote like elements.

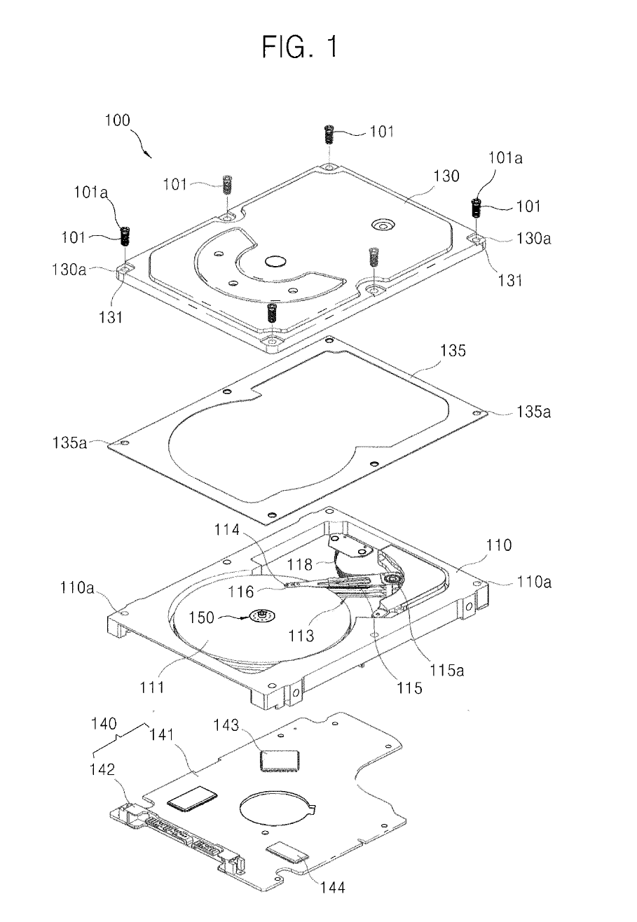

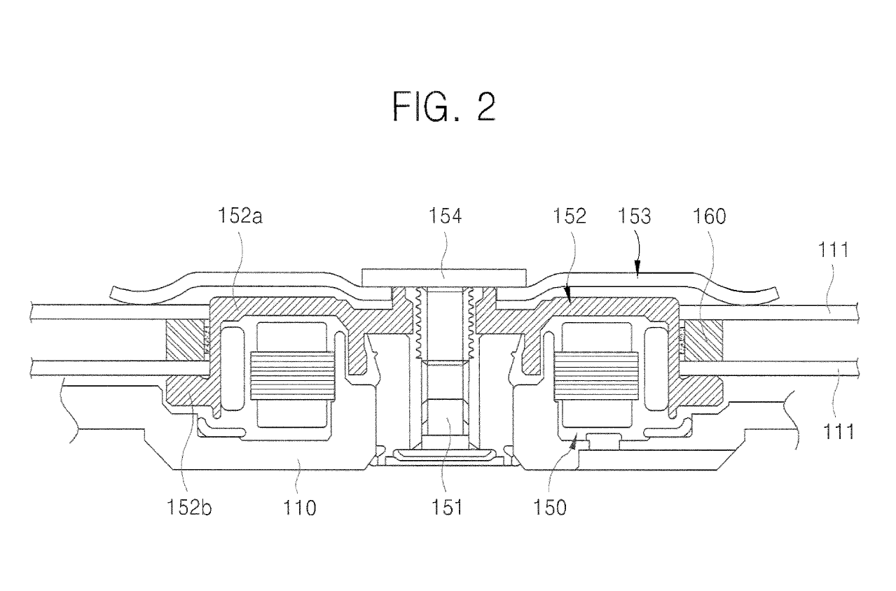

FIG. 1 is an exploded perspective view of a hard disk drive (HDD) 100 according to an exemplary embodiment of the inventive concept. FIG. 2 is a cross-sectional view of the HDD 100 of FIG. 1.

Referring to FIGS. 1 and 2, the HDD 100 according to the present exemplary embodiment may include a base 110 in which a plurality of inner parts (not shown) related to information read and write are provided, a cover 130 arranged above the base 110 with respect to the inner parts interposed therebetween and coupled to the base 110, and a printed circuit board assembly (PCBA) 140 coupled to a lower portion of the base 110.

The cover 130 and the PCBA 140 will be first described prior to a description on the base 110. First, the cover 130 shields an upper surface of the base 110 to protect the inner parts. The cover 130 may be manufactured of a metal material, and particularly, aluminum (Al) alloy by diecasting or a steel material by a press process.

The cover 130 is coupled to the base 110 by using a plurality of screws 101, for example, six screws 101 in the present exemplary embodiment. An indented portion 131 where a head 101a of each of the screws 101 is seated is formed on the cover 130.

When the cover 130 and the base 110 are coupled by using the screws 101, a gasket 135 is provided between the cover 130 and the base 110 as a unit to maintain a seal on a coupling surface between the cover 130 and the base 110. The gasket 135 is manufactured of a rubber material and forms a continuous closed loop along an edge of the upper surface of the base 110 within a range of not interfering with the inner parts.

After the gasket 135 and the cover 130 are sequentially placed on and above the upper surface of the base 110, each of the screws 101 is inserted into a hole 130a of the cover 130 and a hole 135a of the gasket 135 and then coupled to a screw hole 110a of the base 110, thereby coupling the HDD 100.

The PCBA 140 is coupled to the lower portion of the base 110. The PCBA 140 may include a printed circuit board (PCB) 141 on which a plurality of circuit parts are mounted, and a connection connector 142 coupled to one side of the PCB 141. A controller 143 for controlling the HDD 100 is provided on the PCB 141. A plurality of memories 144 for storing various data or tables are provided around the controller 143.

The base 110 is a place where the inner parts related to information read and write are installed. That is, the inner parts including a head stack assembly (HSA) 113, a plurality of disks 111 where data is recorded and stored by the HSA 113, and a spindle motor 150 coupled to a central area of the disks 111 and rotating the disks 111.

The base 110 may include a flat type in which the upper surface thereof is manufactured to be flat and the inner parts are coupled by being stacked thereon, and a bowl type in which the inner parts are coupled by being accommodated therein. Although the base 110 is of a bowl type in the present exemplary embodiment, the right scope of the present inventive concept is not limited thereto and thus the present inventive concept may be applied to a flat type base.

The HSA 113 may include a magnetic head 114 for recording data on the disks 111 or reproducing recorded data, and an actuator 115 for actuating the magnetic head 114 to fly so as to access data on the disks 111. The magnetic head 114 is installed at a leading end of a head gimbal 116 that extends from the actuator 115. As the disks 111 rotate at high speed, the magnetic head 114 is raised by air flow generated on a surface of each of the disks 111 so as to fly over each disk 111 while maintaining a fine gap from surface of each disk 111.

The HSA 113 is rotated toward the disks 111 around a pivot shaft 115a so that the magnetic head 114 writes data to the disks 111 or reads written data. The data is transmitted, via a flexible printed circuit (FPC) 118, to the PCBA 140 that is coupled to the lower portion of the base 110.

The disk 111 is a place where data is recorded and stored by the operation of the HSA 113. In the present exemplary embodiment, two disks 111 are provided and a spacer 160 for maintaining a gap between the disks 111 is coupled between the disks 111. The structure of the spacer 160 will be described later.

The spindle motor 150 may include a shaft 151 for forming a rotation center of the disks 111, a hub 152 provided radially outside the shaft 151 and rotatably supporting the disks 111, a clamp 153 coupled to upper portions of the disks 111 and the hub 152, and a clamp screw 154 for fixing the disks 111 on the hub 152 by pressing the clamp 153. The hub 152 may include a hub body 152a and a flange portion 152b forming a lower end portion of the hub body 152a, according to the location thereof.

The disks 111 and the spacer 160 are assembled on the hub 152 by inserting one of the disks 111 outside the hub body 152a, the spacer 160 thereon, and the other one of the disks 111, and then screwing the clamp screw 154 via the clamp 153. In the present exemplary embodiment, two disks 111 and one spacer 160 are assembled on the hub 152. Alternatively, three or more disks may be assembled with a plurality of spacers inserted between the disks.

When the disks 111 and the spacer 160 are assembled on the hub 152 as described above, although it is ideal that the rotation center of the hub 152 and the rotation center of the disks 111 completely match with each other, that is, the centering of the disks 111 with respect to the hub 152 is accomplished, due to a degree of processing or assembly allowance between parts, it is difficult not only to accomplish the complete centering of the disks 111 with respect to the hub 152, but also to reach a necessary range, by simply assembling the disks 111 on the hub 152. Thus, a centering process is performed.

Nevertheless, as described above, since most of the above conventional centering methods are to reduce the imbalance amount not by precisely performing the disk centering, but by employing an addition process by measuring the imbalance amount after assembly, or merely to allow basic imbalance of a disk to a degree, the quality characteristic of each of the disks 111 varies so that a recording characteristic or a mass production characteristic may be badly affected. Particularly, even when a centering process is performed by the above-described centering method using expensive centering equipment or imbalance equipment, a slip phenomenon may be generated during rotation of a disk and thus setting values may be changed from the initial ones. Therefore, the quality characteristic, for example, repeatable run out (RRO) or non-repeatable run out (NRRO) during servo track writing (STW) or use of the HDD 100, may be affected.

This is because the spacer 160, which weighs much more than the disks 111, has a greater influence on a degree of centering of the disks 111. When the structure of the spacer 160 is improved as described below, the spacer 160 may have a simple structure and be automatically centered with respect to the hub 152. As a result, the centering of the disks 111 may be easier without expensive equipment that is needed in the conventional technology.

Thus, not only the quality characteristic of each of the disks 111 may be maintained constant, but also a bad influence on RRO or NRRO may be prevented.

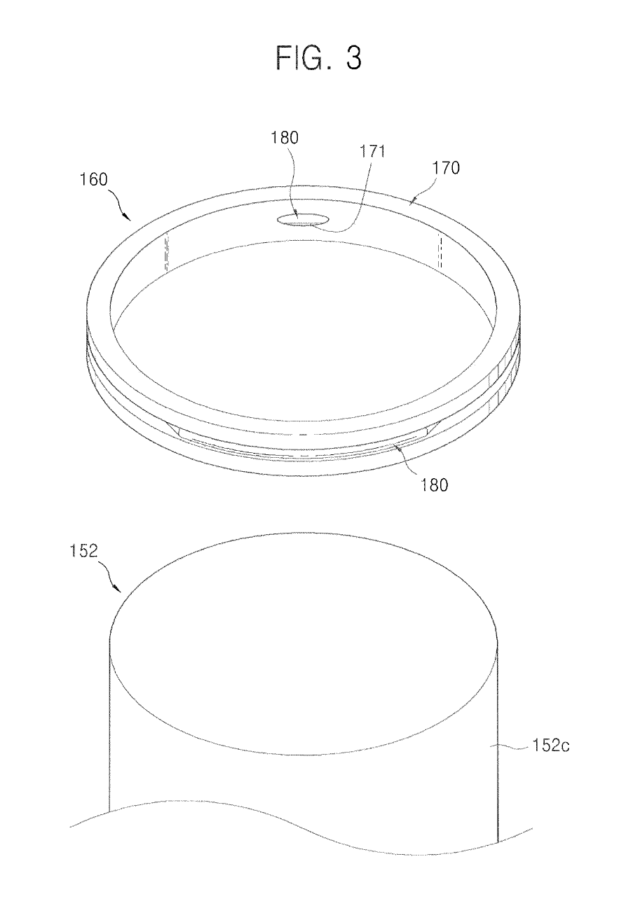

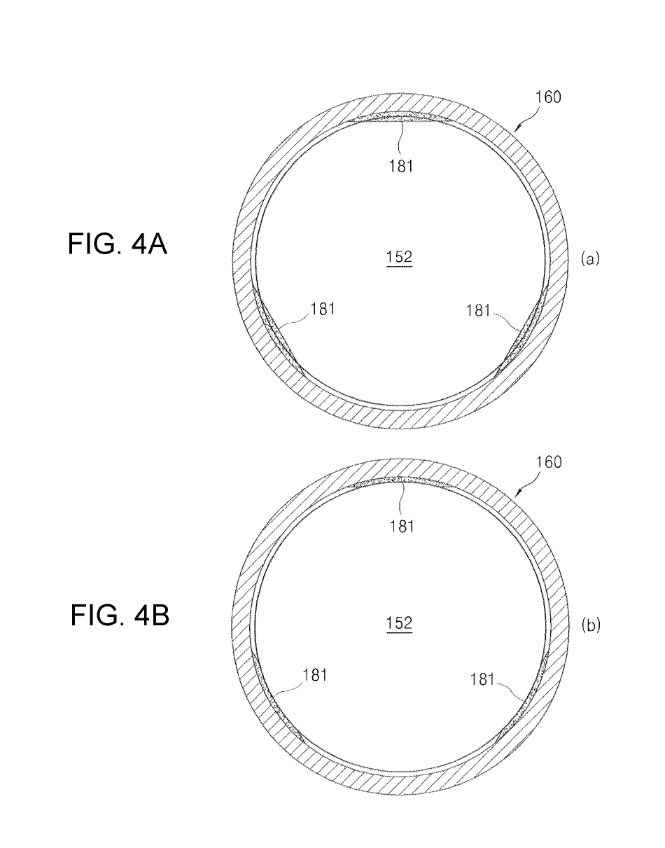

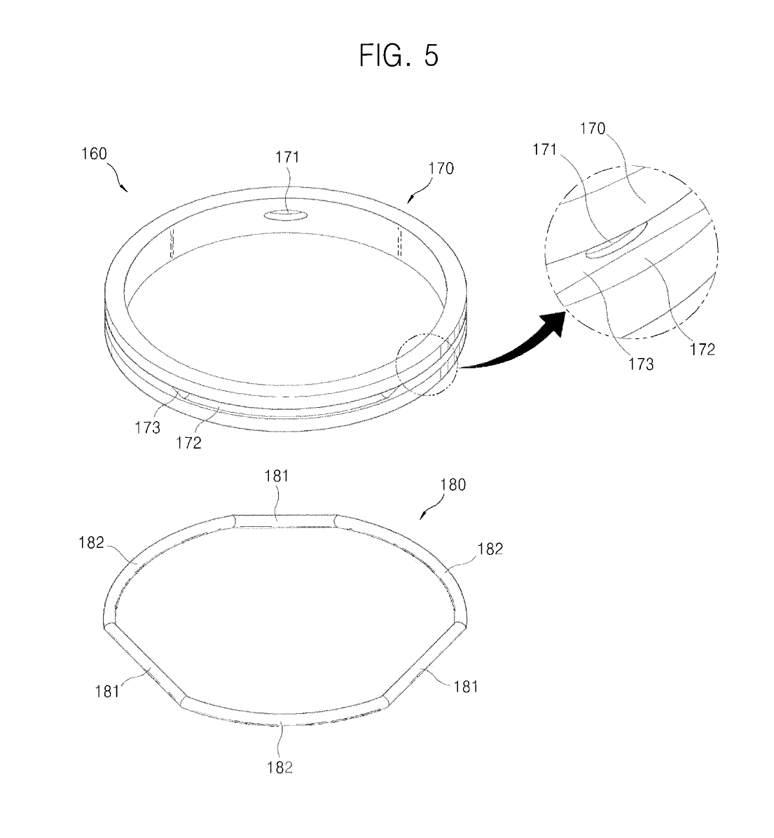

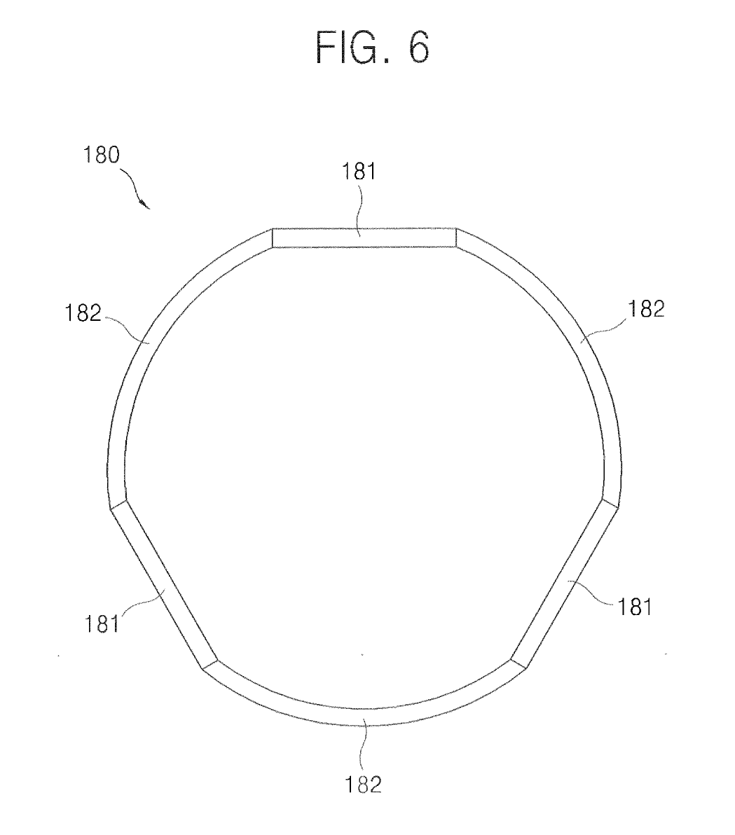

FIG. 3 is an exploded perspective view of the hub 152 and the spacer 160 of FIG. 2. FIG. 4 is a plan view illustrating a process in which the spacer 160 is assembled on the hub 152. FIG. 5 is an exploded perspective view of the spacer 160 according to an exemplary embodiment of the inventive concept. FIG. 6 is a plan view of an elastic band 180 according to an exemplary embodiment of the inventive concept.

Referring to FIGS. 3-6, in the spacer 160 used for the HDD 100 of the present exemplary embodiment (refer to FIGS. 1 and 2), at least one area of an inner wall surface elastically contacts and is pressed against an outer wall surface of the hub 152 for centering with respect to the hub 152.

In detail, the spacer 160 of the present exemplary embodiment may include a body portion 170 and an elastic band 180 formed of an elastic material. The elastic band 180 is coupled to the outer side of the body portion 170, partially passes through a plurality of through holes 171, and is elastically pressed against an outer wall surface 152c of the hub 152 (refer to FIG. 3).

The body portion 170 forms the outer appearance of the spacer 160 and takes most of the weight of the spacer 160. The body portion 170 is manufactured of a metal material, for example, titanium (Ti), in a ring shape. The through holes 171 are formed in the body portion 170 at positions equally separated along the circumferential direction. Each of the through holes 171 has an elongated shape. In the present exemplary embodiment, three through holes 171 are formed. However, the right scope of the present inventive concept is not limited to the above dimensions and shape.

A seating groove 172 where the elastic band 180 is arranged (refer to FIG. 5) is further formed in the outer wall surface of the body portion 170. The seating groove 172 is continuously formed in the outer wall surface of the body portion 170 along the circumferential direction of the body portion 170. Accordingly, the body portion 170 and the elastic band 180 may be easily assembled to each other due to the seating groove 172. Also, the elastic band 180 may be prevented from being disassembled from the body portion 170 after assembly.

Alternatively, a sunken groove 173 that is further sunken inwardly in a radial direction deeper than the depth of the seating groove 172 may be further be formed in the seating groove 172. The sunken groove 173 is formed in an area of each of the through holes 171 where a linear section 181 of the elastic band 180 is arranged. Thus, the linear section 181 protrudes inwardly in the radial direction through the inner wall surface of the body portion 170 by penetrating each of the through holes 171. In the present exemplary embodiment, since there are three through holes 171, three sunken grooves 173 are provided.

The elastic band 180 may include a plurality of linear sections 181 separated at the same interval and a plurality of circular sections 182, each being arranged between the neighboring linear sections 181. In the present exemplary embodiment, since there are three through holes 171, three linear sections 181 and three circular sections 182 are provided.

When the elastic band 180 is inserted in the seating groove 172 of the body portion 170, the linear sections 181 of the elastic band 180 are respectively arranged corresponding to the areas of the through holes 171. Since the sunken groove 173 is formed in the area of the through hole 171 as described above, each of the linear sections 181 is slightly disposed further inwardly in the radial direction due to the sunken groove 173 and partially passes through each of the through holes 171 so as to protrude inwardly in the radial direction through the inner wall surface of the body portion 170. Unlike the above, each of the circular sections 182 is inserted in the seating groove 172 of the body portion 170 and remains therein.

In the present exemplary embodiment, the spacer 160 may be manufactured of fluorine rubber or silicon rubber which may have durability at high temperature. However, any material may be used if it has an elastic coefficient sufficiently to address a slip phenomenon by the centrifugal force generated during rotation of the disks 111 after the hub 152, the disks 111, and the spacer 160 are assembled.

In the operation of the HDD 100 configured as above, the structure and operation of the elastic band 180 will be described below in detail.

FIGS. 4A and 4B are plan views illustrating a process in which the spacer 160 is assembled on the hub 152. In FIGS. 4A and 4B, a dotted line schematically denotes the hub 152. As described above, one of the disks 111 is inserted around the hub 152 and the spacer 160 is inserted thereafter. Then, the other one of the disks 111 is inserted around the hub 152 on the spacer 160. The disks 111 and the spacer 160 may be assembled on the hub 152 by screwing the clamp screw 154 via the clamp 153.

Since the elastic band 180 is further provided in the assembly of the spacer 160 of the present exemplary embodiment and the linear sections 181 of the elastic band 180 protrude inwardly in the radial direction through the inner wall surface of the body portion 170 by partially passing through the through hole 171, three portions of the elastic band 180 that protrude inwardly in the radial direction through the inner wall surface of the body portion 170 overlap the hub 152 at three positions as illustrated in FIG. 4A.

In other words, when the hub 152 and the spacer 160 are initially assembled, the elastic band 180 of the spacer 160 overlap the hub 152 at three positions as illustrated in FIG. 4A. However, since the elastic band 180 is manufactured of an elastic material, when the spacer 160 is inserted around the hub 152 as illustrated in FIG. 4B, the three overlapping portions are pushed outwardly in the radial direction so as to elastically contact and press the outer wall surface 152c of the hub 152 (refer to FIG. 3). That is, the elastic band 180 is extended by an elastic force as much as an amount of the overlapping portion.

Since the linear sections 181 that are the overlapping portion are arranged at the same interval along the circular direction, the elastic band 180 may equally receive an elastic force so that the spacer 160 may be automatically centered on the hub 152.

The automatic centering of the spacer 160 with respect to the hub 152 is not limited to a case of the above-described assembly. For example, when a slip phenomenon is generated in the disks 111 due to an external factor such as impacts or shocks, or for an abnormal reason, during the use of the HDD 100, since the linear sections 181 of the elastic band 180 protruding inwardly elastically support the outer wall surface 152c of the hub 152 at the same positions, the disks 111 may be easily returned to the original centering positions. This feature is advantageous particularly for notebook computers that are subject to severe vibrations due to their portability.

As such, when the spacer 160 with the elastic band 180 is in use, the spacer 160 may be automatically centered with respect to the hub 152 only by inserting the spacer 160 around the hub 152, without using the conventional various centering methods.

Since the spacer 160 as a weight body affecting most of the centering of the disks 111 may be efficiently or automatically centered, the disks 111 may be easily assembled while being centered, without the conventional expensive centering equipment or imbalancing equipment. As a result, a quality characteristic of each of the disks 111 may be maintained constant, and an influence on RRO or NRRO may be prevented.

In the case of the disks 111, verticality in a height direction of a centering device typically affect a degree of centering. In the present exemplary embodiment, however, only precise allowance of the disks 111 and the spacer 160 affect the degree of centering so that superior quality of centering may be guaranteed.

In addition, in the present exemplary embodiment, it is an advantage that the quality of centering during STW or the use of the HDD 100 maybe improved while using the general allowance between the hub 152 and the spacer 160 without change.

Thus, the assembly problem or the generation of particles due to scratches or stabs of the hub 152, which may be generated by making the allowance of the spacer 160 to the hub 152 excessively tight in order to skip centering of the spacer 160 with respect to the hub 152, may be solved so that a bad influence on the quality of a product in the STW process or product assembly process may be prevented.

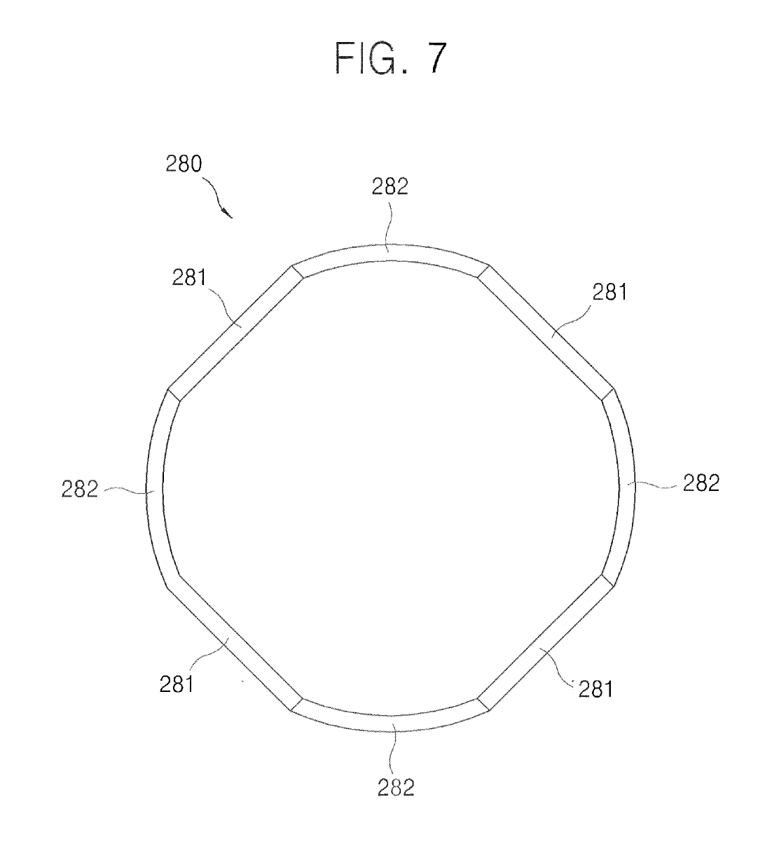

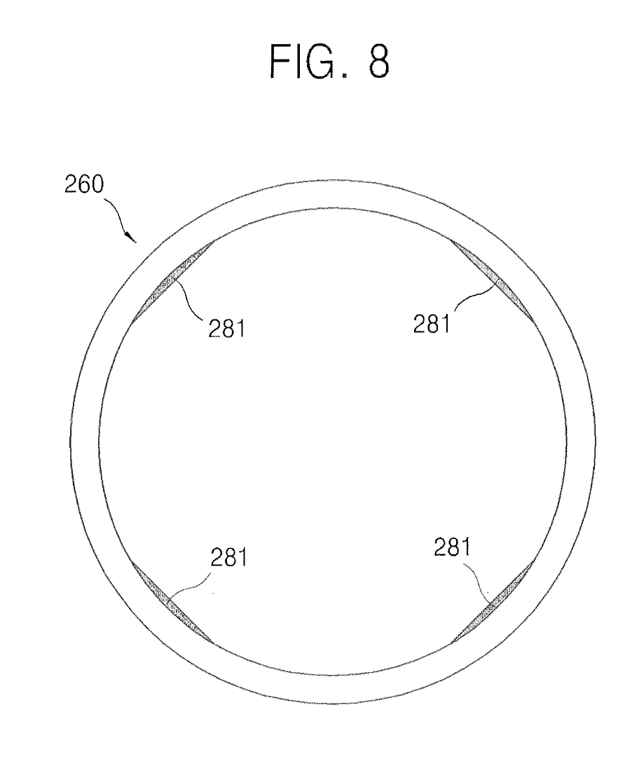

FIG. 7 is a plan view of an elastic band 280 of a spacer 260 according to another exemplary embodiment of the inventive concept. FIG. 8 is a plan view of the spacer 260 employing the elastic band 280 of FIG. 7.

Referring to FIGS. 7 and 8, the function and operation of the elastic band 280 of the spacer 260 according to the present exemplary embodiment are the same as those of the elastic band 180 in the above-described exemplary embodiment, except that the elastic band 280 includes four linear sections 281 and four circular sections 282. The number of each of the linear sections 281 and the circular sections 282 may be four or more. In manufacturing the elastic band 280, the number of the linear sections 281 and the circular sections 282 is not important only when the linear sections 281 and the circular sections 282 may maintain the same interval therebetween in a circumferential direction.

The above-described spacers 160 and 260 do not need to be applied to the HDD 100 only. That is, the spacers 160 and 260 may be applied to an offline servo track writing apparatus that will be described below and thus quality during STW may be improved.

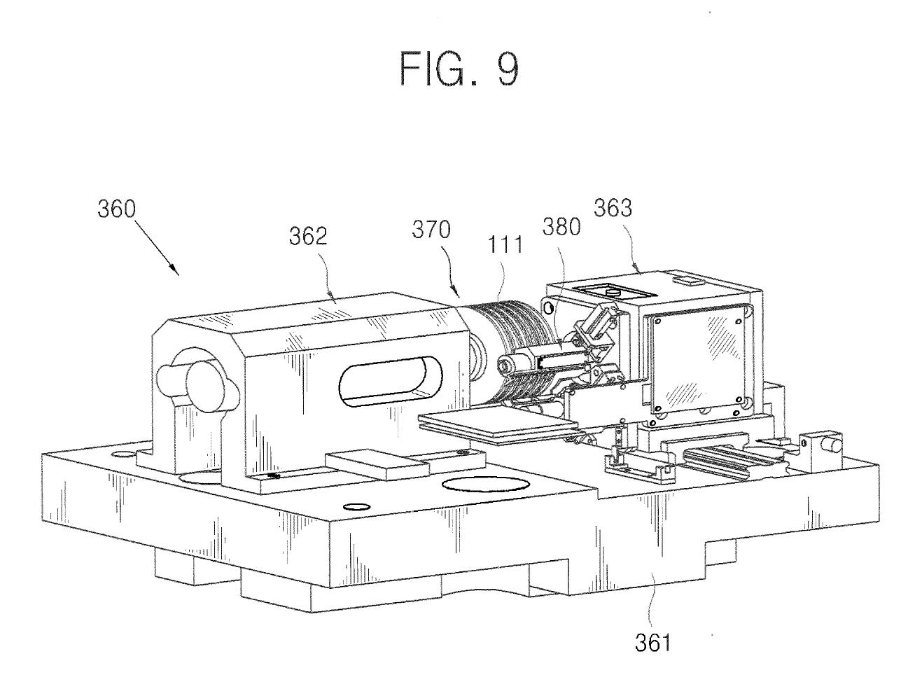

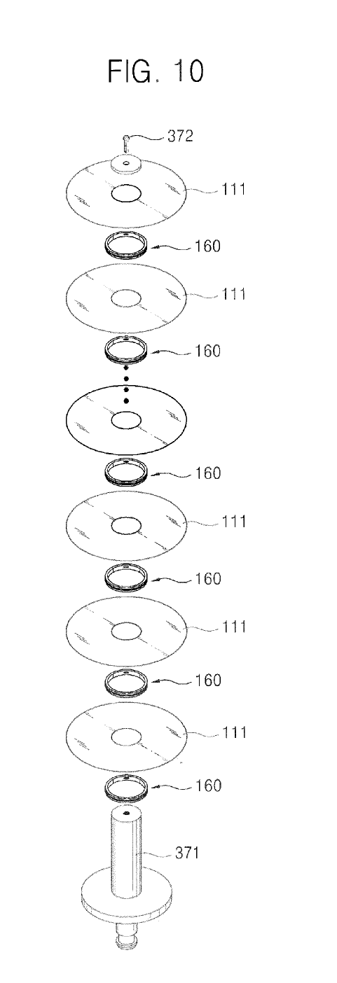

FIG. 9 is a perspective view of an offline servo track writing apparatus 360 employing the spacer according to an exemplary embodiment of the present inventive concept. FIG. 10 is an exploded perspective view of a disk holder, a disk and a spacer.

Referring to FIGS. 9 and 10, the offline servo track writing apparatus 360 may include a bed 361, a disk holder 370 provided above the bed 361 for stacking the disks 111 to which servo track information is to be written, a disk rotating unit 362 coupled to the disk holder 370 for rotating the disks 111, a head unit 380 having a plurality of STW heads (not shown) to write servo track information to recording surfaces of the disks 111, and a head unit driving unit 363 coupled to the head unit 380 for driving the head unit 380.

In the above structure, the disk holder 370 may include a hub 371 on which the disks 111 to which servo track information is to be written are substantially assembled, a plurality of spacers 160 arranged between the disks 111 for separating the disks 111, and a fixing unit 372 for fixing the disks 111 and the spacer 160 to the hub 371. Since the spacers 160 described in the above exemplary embodiment are employed in the offline servo track writing apparatus 360, the disks 111 are automatically centered so that quality improvement during STW may be achieved.

As described above, according to the present inventive concept, since the spacer is automatically centered with respect to a hub in a simple structure, disks may be easily centered without expensive equipment. Also, a quality characteristic of each disk may be maintained constant, and further, an influence on RRO or NRRO may be prevented.

While the inventive concept has been particularly shown and described with reference to exemplary embodiments thereof, it will be understood that various changes in form and details may be made therein without departing from the spirit and scope of the following claims.

What is claimed is:

1. A hard disk drive comprising:
a hub on which a plurality of disks are rotatably assembled; and
a spacer assembled to the hub to be alternately arranged with the disks to separate the disks and having at least one area of an inner wall surface that elastically contacts and is pressed against an outer wall surface of the hub for centering with respect to the hub.

2. The hard disk drive of claim 1, wherein the spacer comprises:
a body portion having a ring shape, in which a plurality of through holes are formed at positions separated at the same interval in a circumferential direction; and
an elastic band formed of an elastic material and coupled to an outside of the body portion to partially pass through the plurality of through holes and elastically contact and be pressed against the outer wall surface of the hub.

3. The hard disk drive of claim 2, wherein the elastic band comprises:
a plurality of linear sections formed at the same interval, arranged in areas of the plurality of through holes to respectively correspond to the areas of the plurality of through holes, and partially passing through the plurality of through holes to elastically contact and be pressed against the outer wall surface of the hub; and
a plurality of circular sections respectively arranged between the plurality of linear sections.

4. The hard disk drive of claim 3, further comprising a seating groove formed in the outer wall surface of the body portion, the elastic band being arranged in the seating groove.

5. The hard disk drive of claim 4, wherein the seating groove is continuously formed in a circumferential direction of the body portion in the outer wall surface of the body portion.

6. The hard disk drive of claim 4, further comprising a sunken groove formed in the seating groove where the plurality of linear sections are arranged, the sunken groove being sunken inwardly in a radial direction deeper than a depth of the seating groove.

7. The hard disk drive of claim 2, wherein the material of the elastic band is fluorine rubber or silicon rubber.

8. The hard disk drive of claim 2, wherein the plurality of through holes are three long holes processed to have the same shape in a circumferential direction of the body portion.

9. A disk spacer for a data storage device that is assembled to a hub to be alternately arranged with disks to separate the disks and is automatically centered with respect to the hub, the disk spacer comprising:
a body portion having a ring shape, in which a plurality of through holes are formed at positions separated at the same interval in a circumferential direction; and
an elastic band formed of an elastic material and coupled to an outside of the body portion to partially pass through the plurality of through holes and elastically contact and be pressed against an outer wall surface of the hub.

10. The disk spacer of claim 9, wherein the elastic band comprises:
a plurality of linear sections formed at the same interval, arranged in areas of the plurality of through holes to respectively correspond to the areas of the plurality of through holes, and partially passing through the plurality of through holes to elastically contact and be pressed against the outer wall surface of the hub; and
a plurality of circular sections respectively arranged between the plurality of linear sections.

11. The disk spacer of claim 10, further comprising a seating groove continuously formed in the outer wall surface of the body portion in a circumferential direction of the body portion, the elastic band being arranged in the seating groove.

12. The disk spacer of claim 11, further comprising a sunken groove formed in the seating groove where the plurality of linear sections are arranged, the sunken groove being sunken inwardly in a radial direction deeper than a depth of the seating groove.

13. The disk spacer of claim 9, wherein the material of the elastic band is fluorine rubber or silicon rubber and the plurality of through holes are three long holes processed to have the same shape in a circumferential direction of the body portion.
